(19) United States
(12) Patent Application Publication
(10) Pub. No.: US 2008/0158605 A1
(43) Pub. Date: Jul. 3, 2008

(54) Method, Device and Computer Program Product for Generating a Page and/or Domain-Structured Data Stream from a Line Data Stream

(76) Inventors: Werner Engbrocks, Pliening (DE); Matthias Fromm, Markt Schwaben (DE); Werner Engbrocks, Pliening (DE)

Correspondence Address: SCHIFF HARDIN, LLP;PATENT DEPARTMENT, 6600 SEARS TOWER, CHICAGO, IL, 60606-6473, US

(21) Appl. No.: 11/578,435

(22) PCT Filed: Apr. 27, 2005
(86) PCT No.: PCT/EP05/04527

§ 371 Date: Jul. 23, 2007

(30) Foreign Application Priority Data
Apr. 30, 2004 (DE) 10 2004 021 269.4

(51) Int. Cl. G06F 15/00

(52) U.S. Cl. 358/1.18

(57) ABSTRACT

In a method for generation of a mapping rule input data of a print data stream structured per line, and which comprises variable data to be printed, are converted into output data of an output data structure. A predetermined structure description file is employed associated with the print data stream and which establishes an arrangement of the data to be printed on a page upon printout. An automatic design data set is automatically generated in which structurally associated print data are comprised structured at least one of per page or per region. The mapping rule is generated by use of a design data set that corresponds to the output data structure. By use of the automatic design data set, the mapping rule describes mapping of data of the automatic design data set to the design data set. The output data structure with respect to content is structured. The output data structure comprises field identifiers that are associated with the data to be printed.

### BACKGROUND

The preferred embodiment concerns a method, a device and a computer program product for generation of a page- and/or region-structured data stream from a line data stream. Such line data streams are in many cases widespread and in particular are formed as an Advanced Function Presentation (AFP) line data stream (which was developed by International Business Machine Corporation (IBM)) or as a Line Coded Data Stream (LCDS) (which was developed by the Xerox Corporation).

Although line data streams (also called line data-based print data streams) stem from the starting times of digital printing, in which characters could only be output line-by-line with mechanical print heads, corresponding print applications are in many cases used today because they were maintained and further developed with great time and personal expenditure over decades and the expenditure for a new development would be unreasonably high and fraught with risks of flawed programming. Such print applications, what are known as legacy applications, are therefore still used in many cases today although today modern print data languages are available that offer manifold possibilities of document preparation, document formatting and document structuring.

The line data code is described from the document S44-3884-02, “Advanced Function Presentation-Programming guide and Line Data Reference”, third edition (October 2000) (which, for example, is accessible at http://publib.boulder.ibm.com/prsys/pdfs/54438842.pdf), published by the International Business Corporation (IBM). Moreover, in chapter three it is described how an output data stream is generated from the original line data code by means of what is known as the page definition file (pagedef).

A computer program with which complex pagedef files and corresponding page association files (formdef files) can be generated (with which pagedef files and formdef files complex documents can be produced) is described in the IBM publication number S544-5284-06 with the title “IBM Page Printer Formatting aid: User guide”, seventh edition (May 2002). A corresponding software program is known from the applicant under the designation Océ SLE (Smart Layout Editor) for Generation of Formdef Files and Pagedef Files.

Output and coding of the Advanced Function Presentation line data frequently occurs on large computers (main frames) in applications specially created for this. FIG. 14 shows such an application, in which a line data print data stream 134 is generated from data of a databank 130 in a customer-specific application. The line data print data stream 134 is then prepared into an output data stream in the further course by means of a preparation program and using the pagedef file 132 and, if applicable, the formdef file 133, which output data stream is sent, for example, to a printing apparatus or to an archive system. The resources pagedef 132 and formdef 133, for their part, call other resources such as font data 135, overlay data 136, code pages 137 and page segments 138.

A data processing system (designated with the trade name PRISMAproduction™) for high-capacity printing systems is offered by the applicant, which data processing system is in the position to process print data streams from various applications, to compile (spool) print data streams under different operating systems such as MVS™ and Linux™ and to convert print data streams into a device-oriented output data stream such as, for example, IPDS™ (Intelligent Data Stream).

A method for processing of document data in which control data are added to the document data in a processing module is known from DE-A1-101 23 376. A method for processing of line data print data in which index data are added to the line data print data in a processing module is known from DE-C2-100 17 785, and a method in which finishing commands can be added to a document data stream is known from DE-A1-102 35 254, which finishing commands can be used for device control for the processing of corresponding printed documents at finishing devices such as cutters, stackers etc.

To convert an AFP data stream into other page definition languages (Page Description Languages, PDLs) such as PDF or Post Script, various conversion programs (for example the software ACM-AFP2PDF Conversion Module) are offered at the Internet address www.mpitech.com by the firm MPI Tech.

A method for conversion of an input document into an output document is known from US-B1-6,336,124, in which method the document is divided into blocks.

Known methods for processing of print data are shown in FIGS. 2 and 3. The print data are thereby sent from a print data source 25 with a sample data set to an editor such as, for example, the Smart Layout Editor (SLE) that the applicant distributes. Using this sample data set the layout (forms, data placement, fonts etc.) is established for printout and an AFP resource data stream with a formdef file and pagedef file is generated. The AFP resources data stream 27 comprises only some tens to a maximum of some hundred kilobytes and comprises forms, fonts, page definitions and form definitions as commands. The AFP resources data stream 27 is then sent to a print preparation computer (print server) 28 and stored there. Given later printout of the print data these are sent directly via the print data path 29 to the print server 28 which connects the print data in turn with the AFP resources data stream and from this generates an IPDS data stream that is sent to one or more printing devices 31, 32 for output.

This processing manner is thus based on the concept that a separation occurs between the variable data to be printed and the resources data stream. Advantages of this method based on AFP are a high processing speed and a high degree of compression since the resources data can be transmitted once as a relatively small file and the majority of the data (print data) can be sent directly from the print data source 25 to the print server 28 without encumbering supplementary information such as layouts, forms, fonts (scripts) etc.

What is disadvantageous in this method based on the IBM product Page Printer Formatting Aid (PPFA) is that only the print data provided in PPFA and predetermined formatting principles can be used. Although personalized documents can be generated via what is known as “conditional processing”, for this a new document page must be described for each derivation. The application design is thereby very protracted and complex. In particular the generation of pie or bar charts is not possible in this manner. This would only be possible via special functions in a correspondingly-expanded printer driver. However, the printout of such applications would therewith be limited to manufacturer-specific systems, which would be relatively disadvantageous.

Resources are static, meaning that they are neither generated nor modified given the execution of a print job. Furthermore, they contain no print data; however, print data samples can be used in the design of the resources.

A data preparation according to what is known as the formatter principle is shown in FIG. 3. The complete print data stream is thereby fed from the print data source 25 to a formatter 35 which generates a layout and directly integrates the layout specifications (such as form specifications, written form specifications and other format specifications) into the print data stream. The complete print data stream so prepared is then sent to the print server 28 and forwarded by this to a printer 31, 32. Such a processing manner corresponds to many methods introduced in what is known as the Small Office Home Office (SOHO) field. For example, print data in the Microsoft Office products WinWord™, Access™ and Excel™ are processed in this manner under the operating system Windows 2000™.

What is advantageous in this type of data processing is that practically arbitrary complex instructions or rules can be integrated into the print data stream. In particular tables with dynamic length (including intermediate and end sums) are possible as well as the graphical preparation of print data via pie or bar charts etc. In principle no limits are thereby set on the representation of print data. Different print data, among other things also what are known as RDI data from databank programs of the company SAP AG (Walldorf, Germany) can additionally be loaded via input filters.

What is disadvantageous in this method is that the print data stream is very extensive (due to the formatting specifications) and thus the transfer of the print data from one computer to another computer or to the printer lasts a relatively long time. Furthermore, the print preparation must occur individually for each print job. Computer programs that apply this principle to AFP print data must generate a complete AFP data stream for every print job, even when no dynamic should occur. For printout these AFP data streams are to be converted into corresponding IPDS data streams for the print devices. It is thereby disadvantageous that the smallest changes to the print job necessitate a complete regeneration of the AFP data stream.

In order to at least partially compensate the (in comparison to formatter-based solutions) very limited formatting possibility by means of formdef and pagedef files, in client applications (for example) dynamic graphics are embedded directly into the line data print data stream, special data fields are inserted for control of “conditional processing” and so forth. Complex dependencies between the customer applications, the formdef or pagedef file and the other resources (such as fonts, code pages, overlays, page segments and so forth) used in the printing process sometimes result both thereby and due to fonts with customer-specific code pages. This leads to the situation that changes and expansions to the layout or to the formdef or pagedef files are very complicated and error-prone.

It is therefore a requirement for line data generating applications to afford possibilities to prepare the line data stream or the resources necessary for formation of the line data stream (optimally without changing the application) via other (for example formatter-based) solutions instead of, as previously, via the formdef file or the pagedef file, and hereby to be able to utilize the more manifold possibilities of the formatter.

The various known method workflows for generation of documents from databanks are shown in FIG. 16. The databank data can thereby be imported from the databank 130 into a line data generator 90 of a host computer 3 which forms a line data print data stream from these. In the host computer 3 this print data stream is imported into a job input system (Job Entry System, JES) from which from the print data stream are selectively supplied to a device driver 33 in the host computer 3 or to a print job assembly module 38 of a print server 28. The print data stream is converted by the device driver 3a into a format adapted to the respective connected device, for example into an AFP or MO:DCA print data stream for an AFP data archive 34 or into an IPDS print data stream for an IPDS printer 31. When the print data have been supplied to the print job assembly module 38, the print jobs can be supplied again to one or more devices, whereby one or more device drivers 33b on the print server 28 are used. The output can in turn occur to an AFP data archive 34 or to one or more print devices 31.

As an alternative to the print data processing method described above, it is known to transfer databank data per field from a databank 130 to a formatting computer program 20a in the host computer or to a formatting computer 20b in the print server 28 and there to provide formatting elements, such that an output print data stream arises that is in turn supplied to the job input system 39 in the host computer 3 or to the print job assembly module 38 in the print server 28.

A computer program with the designation “Pageminer™” for extraction of data from legacy print data streams has been known from the company Elixir Technologies Corporation (Ventura, Calif. (USA)), in which computer program the usable data can be extracted from AFP line data streams according to special rules to be coded and can be stored in a separate values file, such that formatter-based solutions can use this as an input data stream.

### SUMMARY

It is an object to enable a migration from line data print data streams that allows expanded formatting possibilities.

In a method for generation of a mapping rule input data of a print data stream structured per line, and which comprises variable data to be printed, are converted into output data of an output data structure. A predetermined structure description file is employed associated with the print data stream and which establishes an arrangement of the data to be printed on a page upon printout. An automatic design data set is automatically generated in which structurally associated print data are comprised structured at least one of per page or per region. The mapping rule is generated by use of a design data set that corresponds to the output data structure. By use of the automatic design data set, the mapping rule describes mapping of data of the automatic design data set to the design data set. The output data structure with respect to content is structured. The output data structure comprises field identifiers that are associated with the data to be printed.

### BRIEF DESCRIPTION OF THE DRAWINGS

FIG. 1 is a diagram of a high-capacity printing system;

FIG. 2 shows the known method for processing of print data according to the AFP and IPDS specifications;

FIG. 3 shows the known method for processing of print data according to what is known as the formatter principle;

FIG. 4 illustrates a method for preparation of print data with additional structure and formatting elements;

FIG. 5 illustrates the preparation of databank data in a document processing system;

FIG. 6 shows the processing of a sample data set and of an application data set;

FIG. 7 illustrates various print data structures;

FIG. 8 illustrates various print data structures;

FIG. 9 illustrates data structures of FIG. 7 provided with example data sets;

FIG. 10 shows a line data print data stream;

FIG. 11 shows automatically generated data provided with structure elements, which data were acquired from the data of FIG. 10;

FIG. 12 shows a print data stream structured per page and/or per region that was acquired from the data of FIG. 11;

FIG. 13 shows a software structure for generation of a complex formatted print data stream;

FIG. 14 shows a legacy application;

FIG. 15 shows a generalized method workflow;

FIG. 16 shows various known method workflows for generation of documents from databank data; and

FIG. 17 illustrates an excerpt from a pagedef file prepared so as to be readable for people.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

According to a first aspect of the preferred embodiment, a predetermined structure description file associated with the print data stream structured in lines is used for generation of a mapping rule with which input data of a print data stream structured in lines can be converted into output data of an output data stream. In particular a design data set can thereby be established which corresponds to the output data structure. The mapping rule can then be generated such that it describes a mapping between entries of the structure description file and entries of the design data set.

According to a second aspect of the preferred embodiment, a method is specified for generation of a page- and/or region-structured output data stream from a line data input data stream structured in lines, whereby a structure description file is permanently associated with the line data input data stream. A design data set is thereby generated that describes the output data stream, generates a mapping rule between the structure description file and the design data set according to the aforementioned first aspect of the preferred embodiment and, by means of the mapping rule, generates the page- and/or region-structured output data stream from the line data input data stream structured in lines.

According to the third aspect of the preferred embodiment, which can be viewed in combination with or also independent of the two aforementioned aspects, for generation of a page- and/or region-structured data stream from a line data print data stream structured in lines an automatic design data set is automatically generated from line data print data of the line data print data stream using at least one structure description file associated with it, in which automatic design data set structurally associated print data and/or characteristic data associated with them are assembled structured per page and/or per region. Furthermore, by means of a design data set that describes a predetermined data structure and of the automatic design data set a mapping rule is generated that describes the mapping of data of the automatic design data set to the design data set. Finally, the data stream structured per page and/or per region is generated using the design data set, the mapping rule, and the line data print data.

The preferred embodiment is based on the realization that a data stream structured per page and/or per region is suitable as an input data stream for formatter-based solutions for preparation of document data streams or that a corresponding data stream (such as, for example, a comma-separated values data stream) can be generated relatively easily from such a data stream. The data stream structured per page and/or per region thereby essentially comprises data that represent the variable information of documents, whereby field designations can be included to clarify the respective datum, whereby however in particular no formatting instructions (such as fonts, position specifications and so forth) are included. The method of the preferred embodiment inasmuch in particular represents a pre-stage for generation of print and/or document data streams by means of formatters. In particular it has been recognized that a structure description file (such as, for example, a formdef file, a pagedef file or a PPFA script file of an Advanced Function Presentation line data stream, possibly with associated other resources for interpretation of the line data) used for formatting of line data is suitable insofar as the pre-page and/or per-region data structure of the line data can be determined and the mapping rule and/or the automatically-generated design data set can be generated automatically from this.

The preferred embodiment is furthermore based on the realizations that pagedef files in AFP line data print applications in many cases determine the layout of the documents produced with them and that they can then be used as a structure description file to form the mapping rule and/or the automatically-generated design data set.

The mapping rule can in particular be stored in a rule file that is automatically invoked and executed in a productive print process phase. The design data set in particular designates an output structure of the print data and the mapping rule is in particular converted by means of the rule file into instructions for a computer that processes the print data. For automatic creation of the mapping rule, in particular heuristics can be applied that analyze and/or interpret the print instructions of the structure description file and/or characteristic data associated with these according to their actual invocation upon processing of line data of the input data stream.

A maximum degree of compatibility with regard to the print results given a conventional legacy line data print and the, formatter-supported processing of the print data can be achieved via the preferred embodiment, in particular via the usage of a structure description file (such as a pagedef file) associated with the input line data stream, whereby the formatter-based solutions can be integrated into the workflow without elaborate changes to the line data generators being necessary.

In a print environment it is in particular advantageous that the line data print data are processed in exactly the same order as in their standard printout upon formation of the data stream structured per page and/or per region.

In particular the preparation of line data applications according to structure is simplified with the preferred embodiment, whereby the human intervention is simplified relative to previously known methods and is essentially limited to the specification of association rules. The preferred embodiment in particular enables a clear association between sample data (that correspond to the automatic design data set) and the design data set.

The structure description file in particular comprises a page definition file and can furthermore comprise a page association file. These can in particular be an AFP formdef resource or an AFP pagedef resource. Resources (such as, for example, fonts, code pages, overlays and/or page segments) associated with these can in turn likewise be used for generation of the automatic design data set.

Field positions that are specified in the structure description file can in particular be associated with corresponding data sets of the line data print data stream. Furthermore, it is possible to generate an intermediate file before the generation of the structure data set, in which intermediate file are comprised associated (in terms of content and/or structure) line data print data within a structure bracket. In particular Advanced Function Presentation line data print data can be used as line data print data.

The output data stream can in particular be coded in Unicode. In the preferred exemplary embodiment of the invention, code pages of font assignments from the structure description file are checked for consistency with the Unicode coding and conflicts, in particular those that exist due to individual case-specific symbols or allocations of the code pages deviating from the norm, are resolved via code-specific mappings to Unicode.

In particular a comma-separated values print data stream (CSV print data stream) and/or an Extensible Markup Language data stream (XML data stream) can be generated as a print data stream structured per page and/or region. These can in turn in particular be used as an input data stream for a formatter in which a complex formatted print data stream is formed which comprises structure and/or formatting elements that are not available in line data streams. The formatter in particular adds such elements to the formatter input data stream. They can in particular be input or selected by an operating personnel.

With the preferred embodiment it is in particular possible to reconstruct the original databank structure from line data print data streams that were formed from a databank query, and therewith to form an optimal input data stream for formatter-based methods.

A device of the preferred embodiment is set up for implementation of the method. A computer program product generates a method workflow upon its loading and execution on a computer.

In a further advantageous development of the preferred embodiment, the output data stream is generated from a line data input print data stream directly with the aid of the previously generated mapping rule and the structure description file. Furthermore, it can be possible to acquire mapping rules directly from the structure description file, in particular the pagedef file of an AFP line data stream, with which mapping rules the output data stream structured per page and/or per region can be generated.

In a further aspect of the preferred embodiment that can be viewed alone or in combination with the previously described aspects of the preferred embodiment, formatting elements are associated with the line data input print data stream, in particular with an editor, to generate an output data stream structured per page and/or per region from a line data input print data stream structured per line.

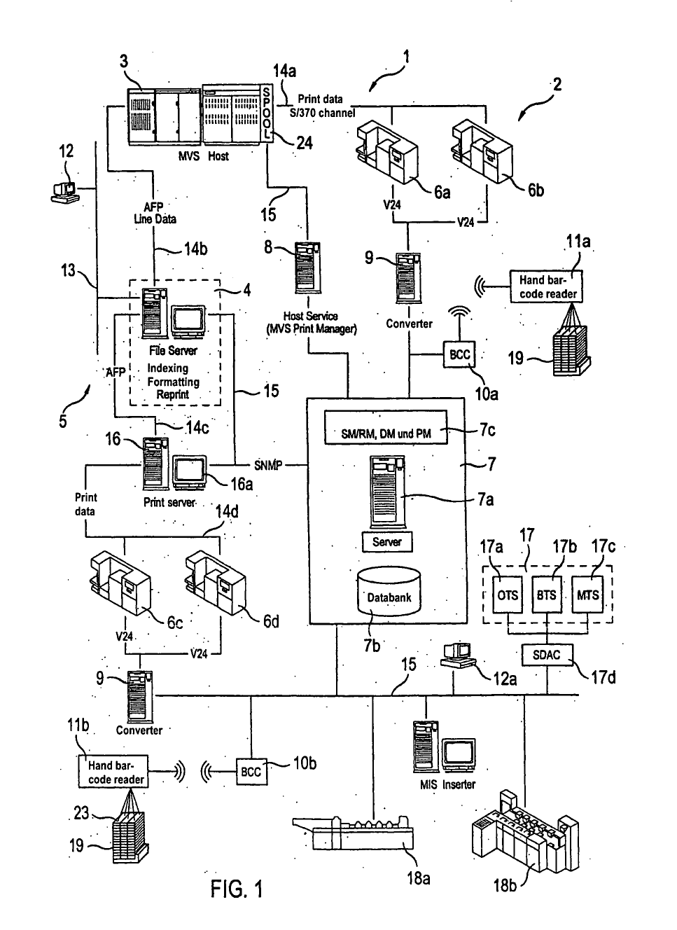

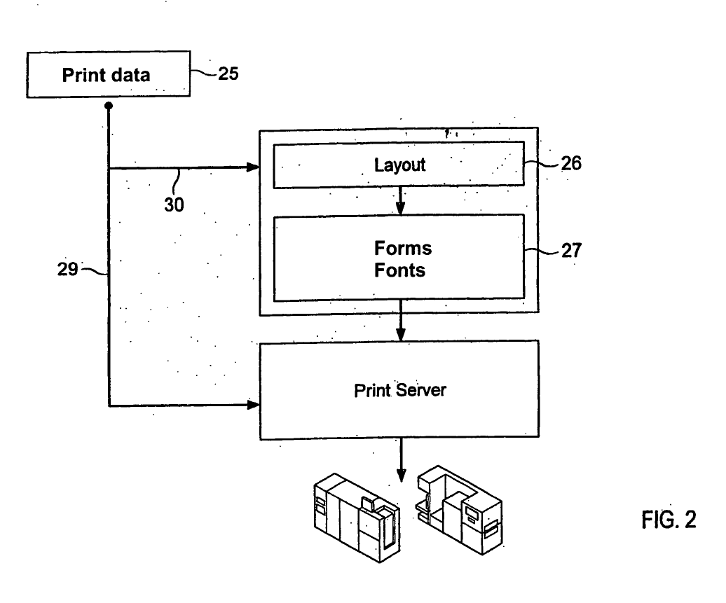

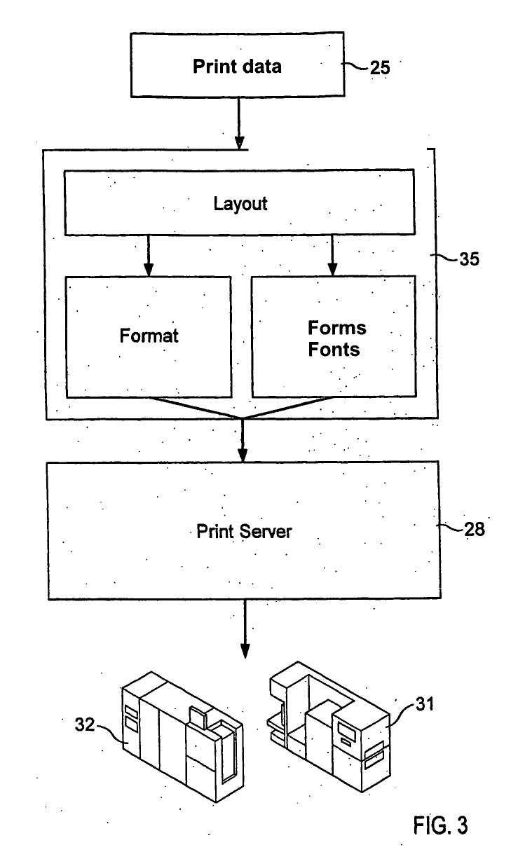

A document print production system 1 is shown in FIG. 1 that, on the one hand, comprises a mainframe architecture 2 and on the other hand comprises a network architecture 5 in which document data or document print data streams are respectively generated by means of user programs (tools). In the mainframe architecture 2 these print data are generated by a host computer 3, for example as an AFP print data stream or as a line print data stream. From the host computer 3 the print data can be selectively transferred via what is known as an S/370 channel 14a directly to one or more print devices 6a, 6b. As an alternative to this output channel, the print data can also be transferred from the host computer 3 via a network 13 or a direct data connection 14b to a processing computer 4 in which the print data are buffered (for example in an associated file server) and processed for subsequent output steps. In particular print data streams that compile regular list expressions, accounts, usage overviews (for telephone bills, gas bills, bank accounts) etc. from larger data sets (databanks) are generated in such host computers 3. Such applications have frequently been in use for many years and are still necessary in a more or less unchanged manner (what are known as legacy applications).

Within the mainframe architecture 2 the print production workflow is monitored by a monitoring system 7. It comprises a monitoring computer 7a that is coupled with a databank 7b and comprises various computer program modules 7c.

The monitoring system 7 is connected with the host computer 3 via a device controller network 15 and a print manager module 8 as well as with, for example, a V24 data line (which connects to both print devices 6a, 6b) via a converter 9. The converter 9 converts the V24 signals into DMI protocol signals of the device controller network 15. SNMP protocol signals can be provided to the device manager DM converted as DMI protocol signals or be directly transferred as SNMP protocol signals.

Print product 19 that was generated in the printers 6a, 6b from the document print data stream and on which barcodes are printed can respectively be scanned with a manually-movable radio-controlled barcode reader 11a. The signals are transferred via radio to the read station 10a and transmitted into the device controller network 15 or to the monitoring system 7. Readers for a one-dimensional and/or two-dimensional barcode can be used as barcode readers such that various barcode systems can be read with one and the same read device. The barcode reader is in particular configurable, i.e. can be applied to various application-specific codes or be respectively suitable monitoring methods.

Document data are generated in the network architecture 5 by means of user programs in client computers 12, 12a that are connected among one another as well as with the processing computer (file server) 4 via a client network 13. The file server thus serves as a central processing and handling interface for print data of the entire print production system 1. Diverse control modules (software programs) run on it, via which control modules the entire print production workflow or the entire document handling is optimally adapted to the respective conditions in a manner that is application-specific, production-related and takes place on the part of the device controller.

In the file server control data that have been supplied in the input data stream from the host computer 3 or user computer 12 to the processing computer 4 can be filtered to the effect that such control data that are not necessary in the given overall system arrangement are removed. Via the connection of all participating output devices (printers 6a through 6d, cutting device (cutter) 18a, enveloper 18b via the device control network 15 it can already be decided in the processing computer 4 which control data of the input data stream are needed by none of the connected devices. Via removal of these data from the data stream the data stream can be reduced overall, in particular when only empty field entries regarding corresponding control data are contained in the input data stream.

When an error occurs in the course of the further processing of the data (in particular in the output of the data to one of the print devices 6a, 6b, 6c or 6d, in one of the post-processing devices 18a, 18b or also in the print computer 16), this error can be established by the monitoring system 7 using the control barcode inserted into the processing computer 4 and the reprinting of the documents (pages, sheets, mail pieces) affected by the disruption can be requested. This repeat print request is significantly controlled in the processing computer 4.

Print data that have been produced by the processing computer 4 are directed via the print data line 14c to a print server 16. Its task is essentially to unburden the processing computer 4. This occurs via buffering of the produced print data until their recall via the data line 14d to one or both printers 6c, 6d. The print server is thus primarily integrated into the overall system for reasons of performance (speed). In systems whose print speed is less high, the print server 16 can also be omitted.

Document data that are transmitted to the printer 6c or to a 6b and there are printed on a recording medium (for example paper web) are, in the overall system, supplied to further processing stages, namely to the cutter 18a and the enveloper 18b for further processing. The print production process is thus concluded.

The printed documents are tested with a test system 17a with regard to various criteria on their processing path between the print device 6 and the last post-processing device 18b, namely by an optical test system 17a with regard to their optical print quality, with a barcode test system 17b with regard to their presence, their consistency and/or their order as well as with an MICR test system 17c insofar as the print was printed by means of magnetically-readable toner (Magnetic Ink Character Recognition toner). The data (supplied from the test system 17) of the various test systems are transmitted from a common, serial data acquisition module (serial data acquisition module) 17d to the device controller network 15 and supplied to the monitoring system 7. There the respective system data are collected and the devices are checked in real time and the respective positions of the documents are tested with regard to their corrections relative to the print job.

The finished, printed documents 23 can in turn be detected with a barcode reader 11b that is, for example, connected in a radio-controlled manner with an associated control device 10b which in turn supplies its data to the monitoring system 7 via the device controller network 15.

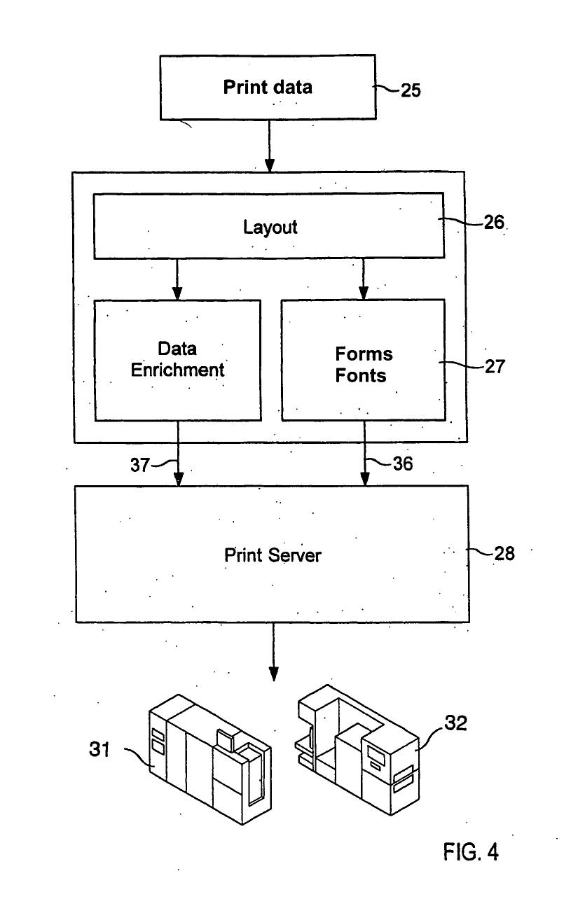

In FIG. 4 a method is shown for preparation of print data with additional structure and formatting elements as is described in WO-A1-2004/040432 (not previously published) by the applicant. The content of this patent application is thus incorporated by reference into the present specification.

With the aid of the layout editor, static resources are thus created using a complete print data sample. These are the standard resources (such as overlays, page segments, fonts, pagedef and formdef files) known in the AFP data stream. Print data that, however, are not contained by means of the standard formatting offered in the AFP function spectrum are, however, written not into an AFP resource file but rather into an expanded print data file comprising all variable print data. This file is used for individual design with particular formatting elements, for example graphical elements such as pie charts or bar diagrams. For this the editor 26 is expanded such that such formattings can be implemented. The basic concept of the AFP data structure, namely the data separation between variable and static data, is thereby nevertheless largely retained. From the formatter principle it is retained that the print data are entirely transferred to an intermediate stage. In this intermediate stage (as is provided in the processing of AFP print data) resources are associated with the print data and thus forms, fonts etc. are harmonized and converted into a relatively small AFP resource data stream. This resource data stream is transferred via an AFP channel 36.

Furthermore, those data that are already formatted differently or given which no performant conversion or association of AFP resources is possible are chosen from the variable print data. These print data are correspondingly expanded with the necessary commands (data enrichment). This print data expansion occurs in what is known as a design phase by means of a suitable editor in which corresponding sample data sets or automatic design data sets are examined and corresponding associations are made. For example, a data table could be drawn upon and the command can be associated that a pie chart as a graphical element is to be generated from the numbers standing in the data table. A suitable new computer program can alternatively be provided as an editor or an already-existing editor can be expanded with corresponding functions for a specific print language (for example an AFP editor like the aforementioned Smart Layout Editor (SLE) from the applicant).

In a productive phase, meaning while the variable print data stream is transferred from the data source 25 to the print server or directly to one of the print devices 31, 32, the correspondingly expanded print data stream is sent to the print server or, respectively, printer via the data channel 37. In the print server 28 or, respectively, printing device 31, 32 the prepared print data stream is combined with the AFP resources (transferred once) and finally the data stream so combined is sent to the printer as an IPDS data stream. A printout can also ensue as a telefax at a fax machine, the data are sent as e-mail via an e-mail computer (for example via the client computer 12) or are placed on the Internet via a WWW server.

It is thus possible on the one hand to transfer standard data performant because these data are not overloaded by formatting instructions and, on the other hand, to transfer those data formats which cannot be described or can only be laboriously described in AFP to the print server simply and quickly.

In the method described above it is provided to expand the processing manner known from AFP environments by at least one functionality via which formatting instructions (such as the representation of graphical data, for example the conversion into pie or, respectively, bar diagrams or the addition of components such as barcodes, images and other objects) can be transferred within the print data.

One advantage of the described solution is thereby on the one hand the working compatibility with the known environments and on the other hand the possibility to be able to furthermore use existing, always-recurring print jobs. A 100% backwards compatibility of the method in print production environments can thus be ensured. Print data streams that have been generated under earlier editors, such as line data streams (line data streams), can furthermore be directly transferred to the print server or printer via an expanded layout or, respectively, editor module. For this a pagedef file generated earlier is merely adopted into a document template.

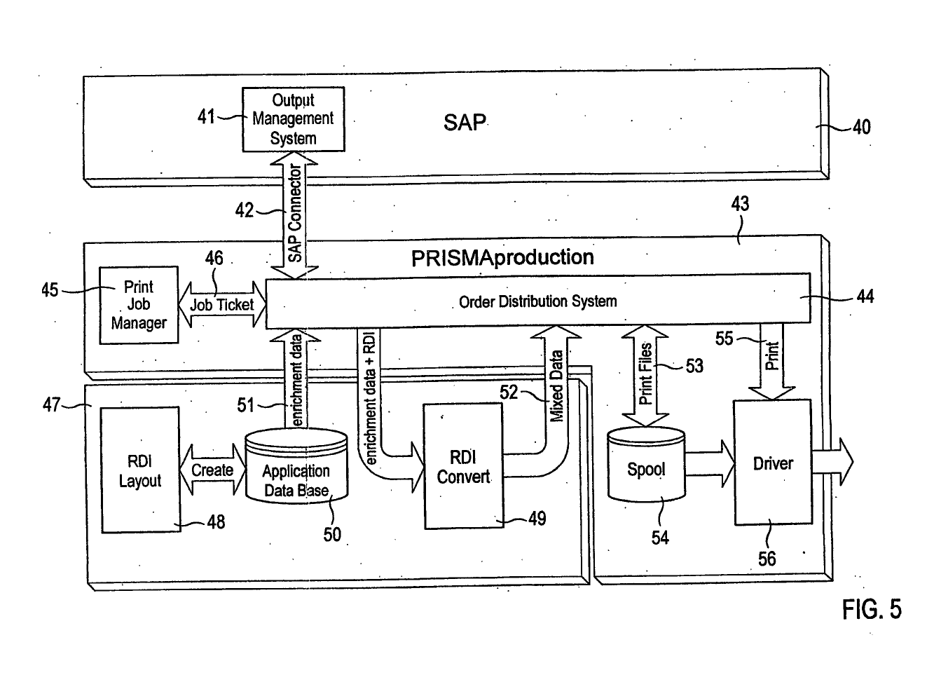

In FIG. 5 it is shown how computer program products interact so that data that originate from an SAP databank application are prepared with formatting information and are prepared in a print production system such that they can be sent to a print device. SAP-specific RDI print data are sent from the SAP databank application 40 to a print production system 43 via an output data management system 41 (output management system) and an SAP interface 42 (SAP connector). There print jobs are administered by a job distribution system 44 (order distribution system) for the further processing. Every print job is thereby individually identified by means of a print job manager 45 (print job manager) and provided with print job data, for example for a desired output printer or a certain priority. These data stand in a print job corollary file 46 (job ticket). A data expansion module 47 serves for preparation of print data from a user databank. This data expansion module 47 comprises two computer program modules 48, 49 that are required at various points in time.

In a data preparation phase the data of a sample data set from an application databank 50 (for example SAP databank) are drawn upon and suitable formatting data and other expansion data are appended to the sample data set by means of the designer module 48 in order to prepare said sample data set according to the desire of a user. Suitable expansion data 51 are then transmitted to the document generator computer program 49 via the job distribution system 44. With the document generator computer program 49 the RDI data as well as the associated formatting data are additionally converted into a print data format internally predetermined and coupled to a print system or selected by a user. The conversion can thereby, for example, occur into an AFP data stream, a PCL data stream, a PostScript data stream or even a PDF data stream.

The computer program module 49 uses the expansion data in a second processing phase in which the complete databank data are transmitted from the SAP databank application 40 via the SAP interface 42, to be supplemented data set for data set with the expansion data. In this manner personalized documents 52 are created that are output as print files 53 to a collection program 54 (spool) via the job processing system 44 or as direct print data to a printer (not shown in FIG. 5) via a printer driver module 56.

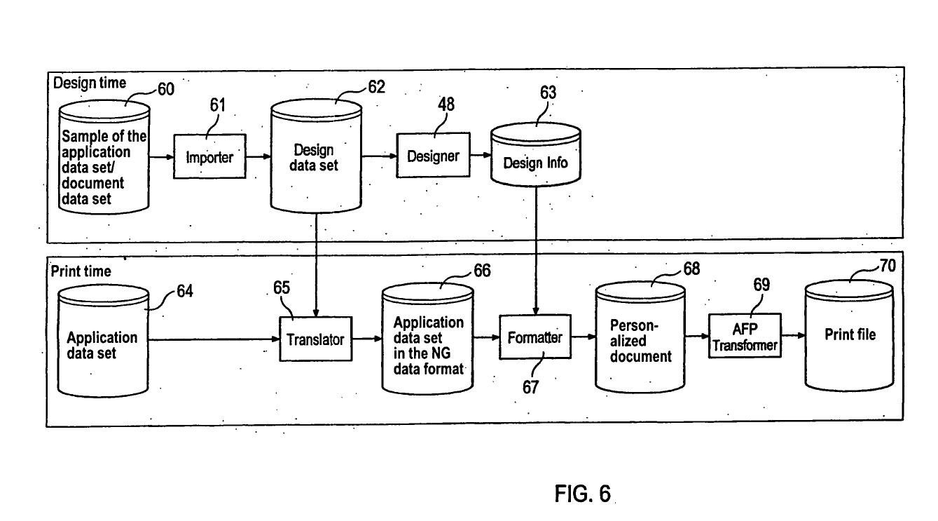

Shown in FIG. 6 are the data processing processes that are implemented on the one hand in the preparation phase (design phase) and on the other hand in the production phase (print phase) in order to be able to prepare print data from arbitrary sources. A sample data set or a sample document 60 that originates from the line data stream is loaded at the design phase into the designer computer program 48 as a design data set 62 via an import module 61. Using this program 48 arbitrary formatting or expansion information is added to the design data set 62 and thus the design information file 63 is formed. In the design phase an automatic design data set is moreover automatically formed by means of the pagedef file and pattern data and a mapping rule is generated manually, semi-automatically or entirely automatically using a logical comparison of the automatic design data set and the design data set 62.

At the print phase application, data sets 64 of the line data print data stream are imported data set for data set and translated by means of a translation computer program module 65 of the document generator computer program 49 into an internal data format 66. By means of the mapping rule attained in the design phase or the rule file (from the application data set 64) containing this mapping rule, the translator 65 forms the application data set in the internal data format 66 to which a computer program module “formatter” of the document generator computer program 48 is then applied using the design information file 63.

From the print data in the internal data format and the formatting rules (which are stored in the design information file 63) defined by the design process, the formatter computer program module 67 generates the personalized document 68. A data transformation module 69 (AFP transformer) converts the personalized document file 68 into a print file 70.

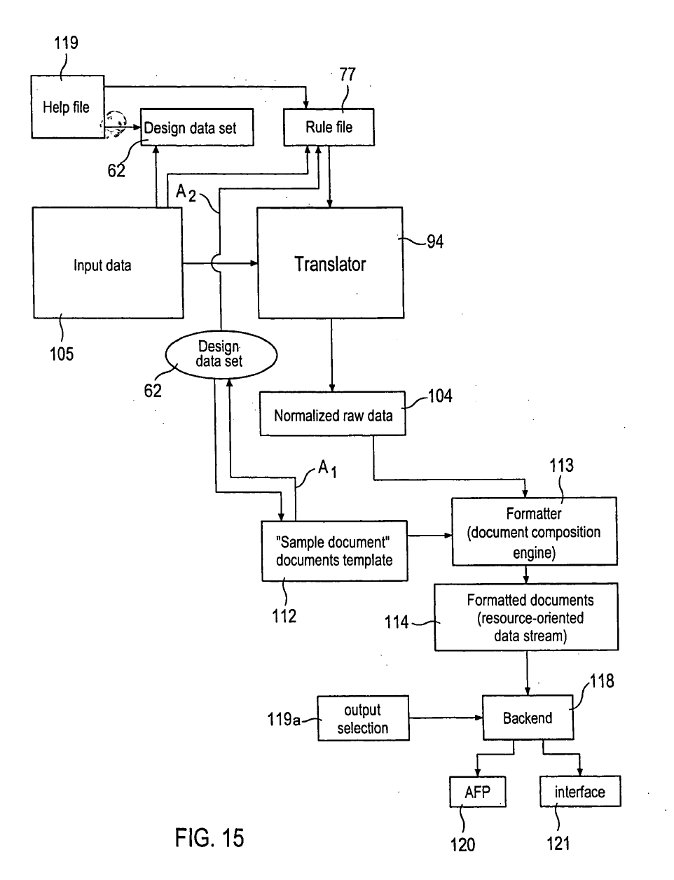

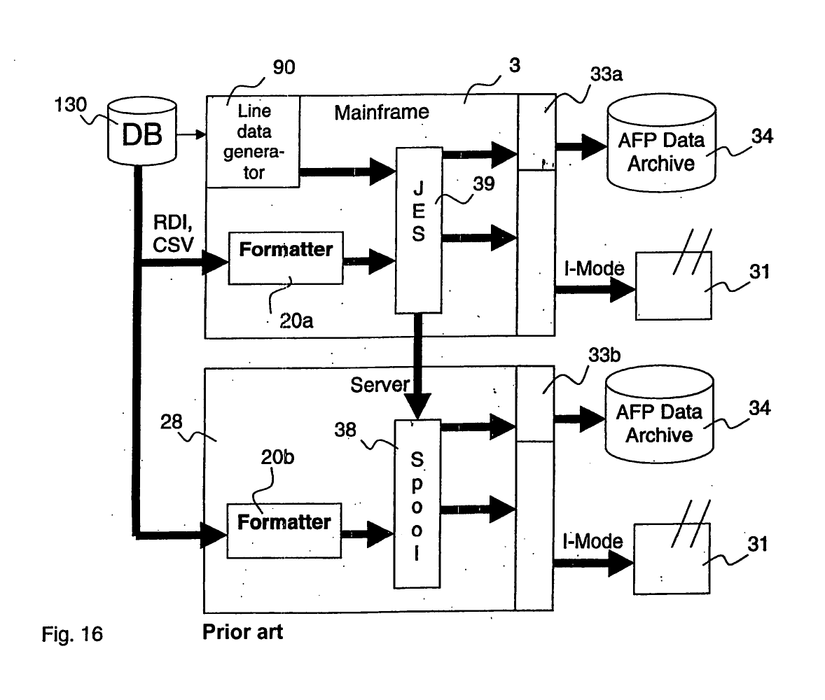

The method workflow described above is shown again generalized in FIG. 15. A translation stage module 94 that is controlled by the rules file 77 serves for conversion of the input data 105 into the normalized data 104. The rules file 77 comprises mapping instructions in the form of mapping rules that have been formed in the design phase from the input document data 105 or from the automatic design data set 62 derived therefrom and the design data set 62 likewise created and, if applicable, from input data-specific supplementary files 119. Both the design data set 62 and the rules file 77 can be freely editable. The design data set 62 can be used in the formation of a document template 112 that controls the formatting of the normalized data stream 104 (in stage 113). As shown with arrows A₁ and A₂, the design data set 62 (and from this the rules file 77) can also be generated from the document template 112.

The mapping rules specified in the rules file 77 are specifically for the input document data stream 105. They specify which element of the input document data stream 105 is to be associated with which element of the design data set. The design data set 62 comprises the structure definition of the normalized data, whereby type declarations are provided for various structure elements, for example for customer numbers, names, logos, images etc. Data groups can then also be formed in the normalized raw data 104, which data groups belong in particular to all of those data that belong to a document. For each document all data belonging thereto are thus available in a normalized raw data stream 104. A document template 112 serves as a structure pattern for the documents to be generated and describes which formatting instructions are to be added into the normalized data stream. It can contain elements from the design data set 62 and/or contain freely-programmed static or dynamic elements 96, 93, 15. The document template 112 is thus dependent on the document formatting and serves to control the format formation device 113 (formatter or document composition engine).

A resource-oriented data stream is formed from the normalized raw data stream 104 via the formatter 113. Insofar as formattings are already contained in the raw data these are retained, and insofar as the raw data are unformatted and formatting specifications are contained in the document template with regard to the corresponding data fields, these are added into the formatter 113 in a resource-oriented manner, whereby resources that are required multiple times within a data stream are further processed in a performance-oriented manner, meaning that they are inserted into the resource-oriented data stream primarily through retrieval of the resources, whereby the resources are themselves only internally present once or can be externally loaded from a resource file or also can only be referenced. For handling of document template 112, design data set 62 and rule file 77, it can be advantageous to couple these files in the manner that a variation in one of the files leads to a consistency check and, if applicable, modification in both of the other files.

The formatted document data stream 114 is then supplied to a back-end device 118 in which it is selectively prepared in the output language (controlled by an output selection file 119a) as a print data stream 120 or via an interface 121 for an output device (telefax, e-mail server, WWW server, monitor). The normalized data stream 104 and/or the formatted data stream 114 can likewise already be optimized specific to the device. Details in this regard are described in WO-A2-01/78000, which is herewith incorporated by reference into the present specification.

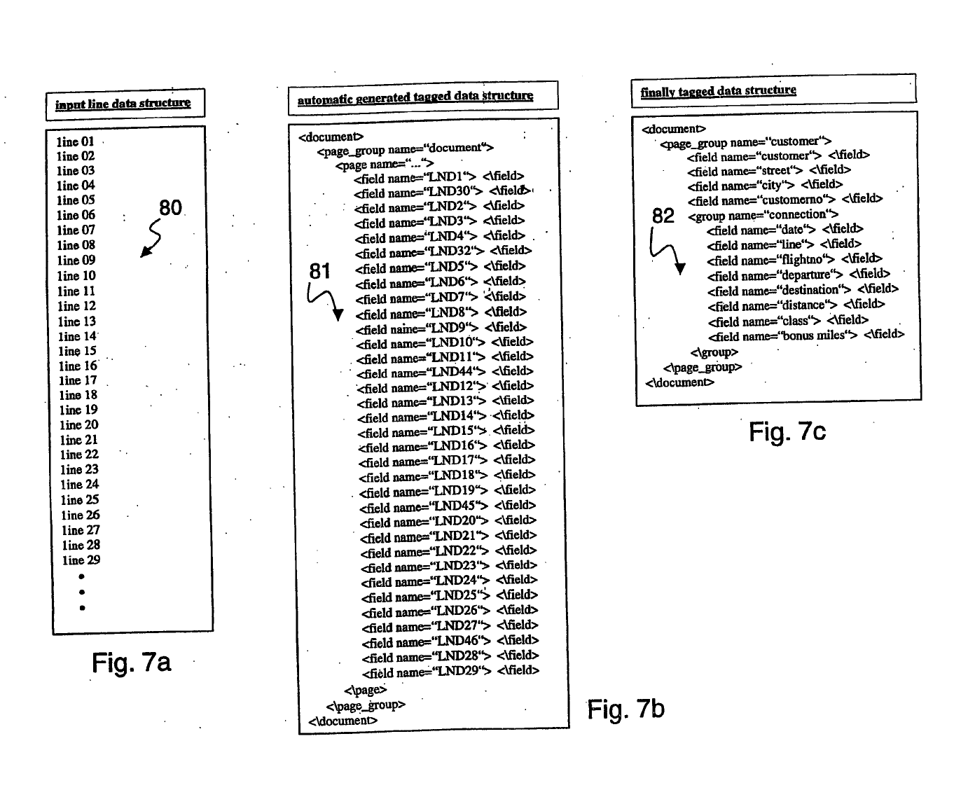

The method for generation of a data stream structured per page and/or per region from a line data print data stream structured per line is explained in detail in FIGS. 7 through 13 and 17. An AFP line data print data stream structured per line is shown structurally in FIG. 7a, whereby the line data (Line 01, Line 02, . . . ) 80 follow one another line-by-line in a structured manner. A structure description file “pagedef” that establishes the arrangement of the respective data on the page upon printout of the line data 80 is associated with the AFP line data. If one uses the pagedef file, using the instructions from the pagedef file a new data structure 81 can be automatically generated from the line data 80 structured per line, in which new data structure 81 page groups belonging together as well as individual pages can be represented on the one hand and, on the other hand, the line descriptors (LND) originating from the pagedef file are associated with the respective fields from the line data structure within each page. Using this per-page design of the data structure, by means of data input or selected by an operator a rule file (association file) can then be formed with which a final, labeled data stream with the structure 82 (shown in FIG. 7c) structured in regions and provided with field identifiers 82 (customer, street, city) can be generated from the data stream 81 structured in pages, in which structure 82 a field of the input data stream 80 is associated with each field identifier.

The automatically generated, labeled data structure 81 is a first exemplary embodiment for an automatically-generated design data set. In the present case it comprises primarily field names as information. However, it can contain additional further identifying data such as, for example, font information and position information that can in particular be acquired from the pagedef file. The automatically-generated labeled data structure 81 or the automatically generated design data set reproduces structure information of the pagedef file, in particular with regard to data formats that must be recognized.

While the automatically-generated labeled data structure 81 is structure-less with regard to the data contents, the ultimate labeled data structure 82 exhibits a structure with regard to content. In the present example the structure with regard to content corresponds to a flight overview of a flight passenger, whereby various structure criteria with regard to content are represented by the field names “Customer”, “Street”, . . . “Connection”, . . . “Flight NO” etc.

The ultimate labeled data structure 82 represents a structured sample data set in which line data print data that belong together structurally are assembled by region, structured with regard to content. Using this sample data set and the line data print data the page-structured and/or region-structured data stream that is suitable as an input data stream for a formatter can then be generated.

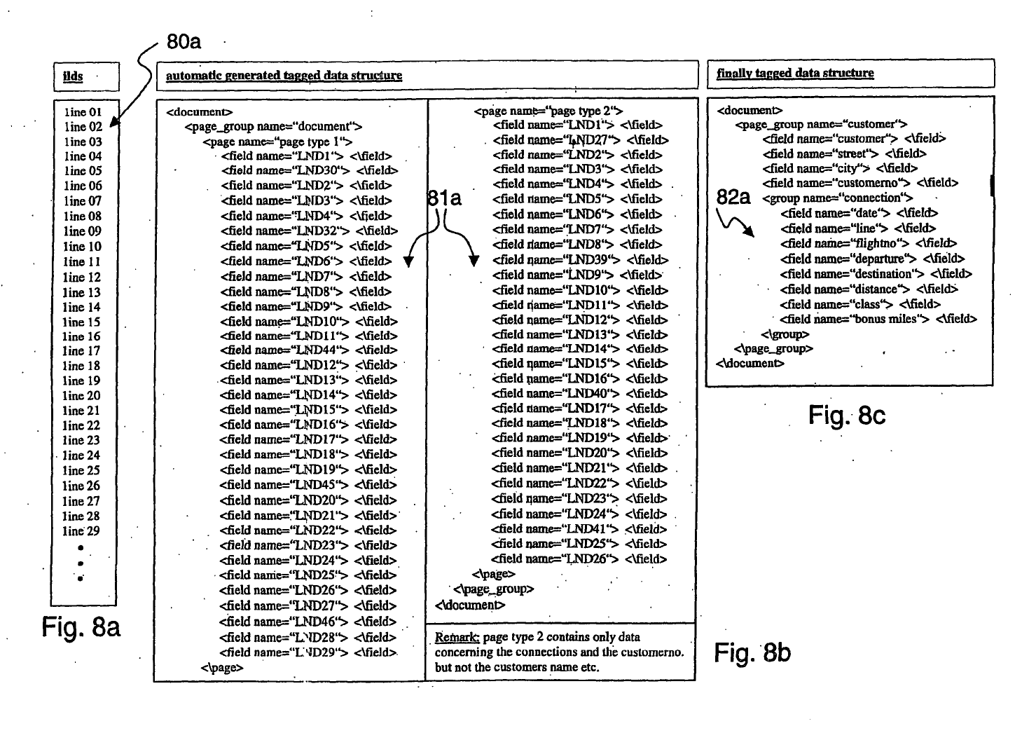

A data stream structure similar to as shown in FIG. 7 is shown in FIG. 8, whereby there the line data 80a are divided up into two page types by the structure description file (page definition), and whereby different line descriptors are used in each page type. For example, it can thereby be effected that name and address of the flight customer are respectively reproduced in the page type 1 while only the customer number and the flight connections are specified in the page type 2 but not the customer name etc. The data structure 82a of the sample data set that reproduces the structure with regard to content is, however, thereby identical to the corresponding data structure 82 of FIG. 7. The automatically-generated marked data structure 81a is a further exemplary embodiment for an automatically-generated design data set.

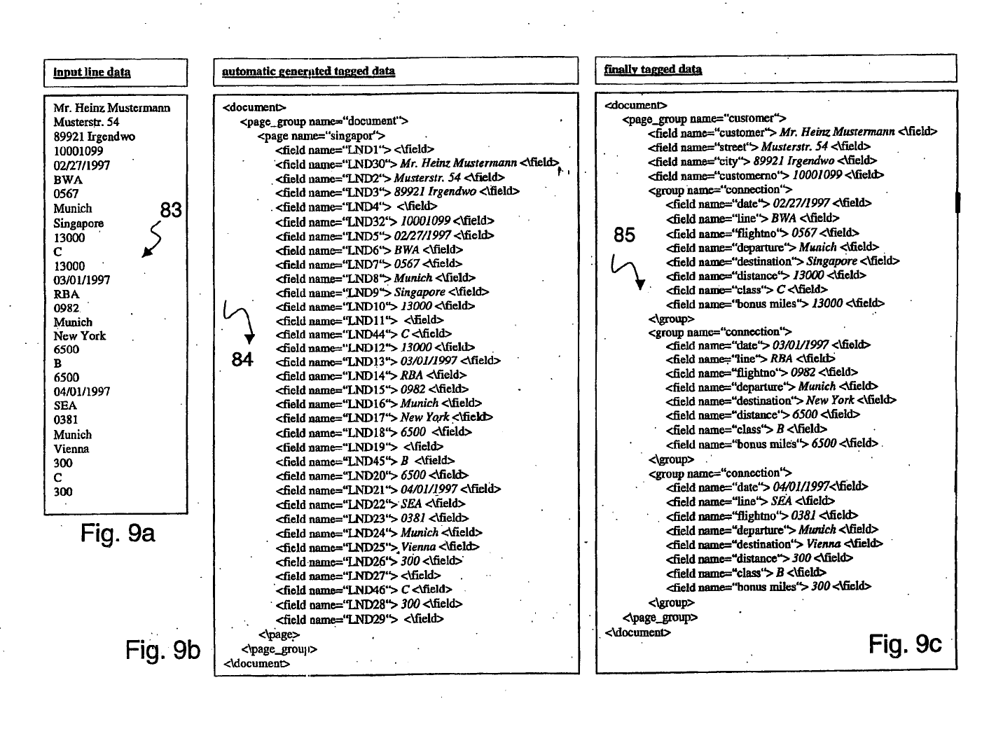

A labeled data structure 83 that comprises three flight connections (Munich—Singapore, Munich—New York and Munich—Vienna) for Mr. Heinz Mustermann is shown in FIG. 9a. From the interpretation of the associated pagedef the labeled data stream 84 is automatically generated, whereby the corresponding line descriptor (LND) of the pagedef that processes this line datum is associated with each datum of the line data stream 83. The page structure is additionally labeled in the data stream 84. Shown in FIG. 9c is the data stream 85 structured with regard to content and per region, which data stream 85 is formed from the automatically-generated, labeled data stream 84 as well as a rule file which comprises the respective mapping rule of the data fields both with regard to a field name and with regard to one or more group names (customer, connection). The rule file is wholly-automatically, semi-automatically or manually generated, whereby the data structure of the automatic design data set is advantageously used. In the present example it is recognizable that a flight connection respectively has eight entries, i.e. each ninth entry in turn represents a new flight connection. To recognize such a structure certain channel control characters can also be sought just as well, for example the channel control character 1 which means that a new document begins. As soon as such rules or trigger mechanisms for recognition of the regions have been established, a data stream structured in regions with regard to content can be automatically generated from a line data print data stream. In order to ensure that all conceivable data constellations that are to be processed with a predetermined structure description file can be converted into a data stream structured in regions with regard to content, it can in particular be checked with machine support whether all formatting rules (in particular line descriptors) of the structure description file have been converted into a corresponding region recognition or group recognition rule in the rule file.

A corresponding data stream 85 structured in regions with regard to content is shown in FIG. 9c, which data stream 85 can be generated directly from the input labeled data structure 83 with the corresponding rule file.

For generation of the automatically-generated design data set, in particular a page definition file (such as, for example, a pagedef file known from the documents of the prior art cited in the introduction or a corresponding script file from a page formatting tool such as the IBM Page Printer Formatting Aid) is used as a structure description file. Its associated resources (such as fonts, code pages or page segments) can additionally be used as well as a page association file such as AFP formdef, if applicable with its associated resources (such as fonts, code pages, overlays or page segments) can be used.

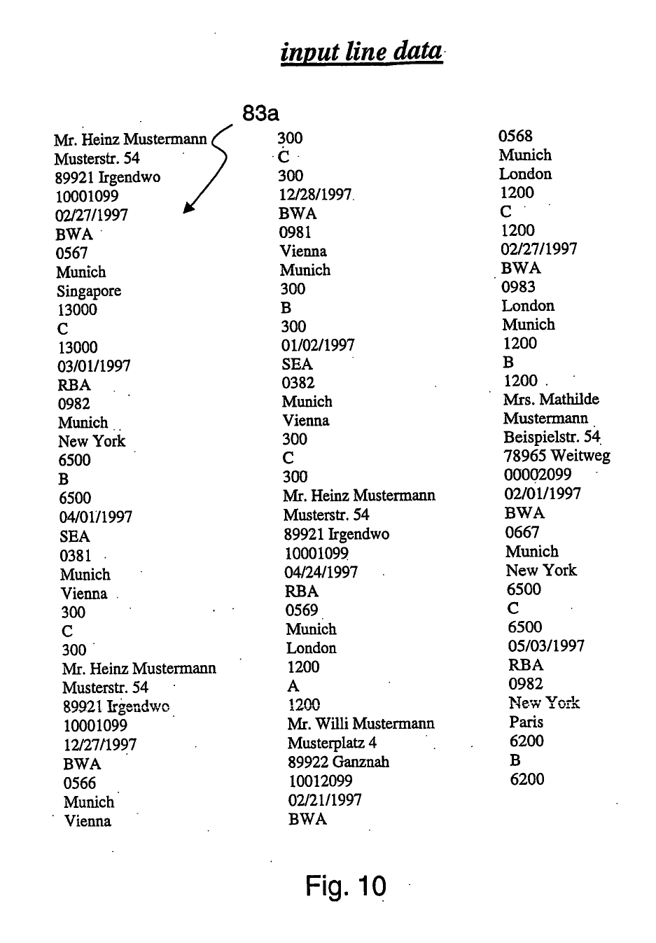

A somewhat more complex labeled data structure 83a is shown in FIG. 10 in which data of other flight passengers are contained in addition to various connections of one flight passenger.

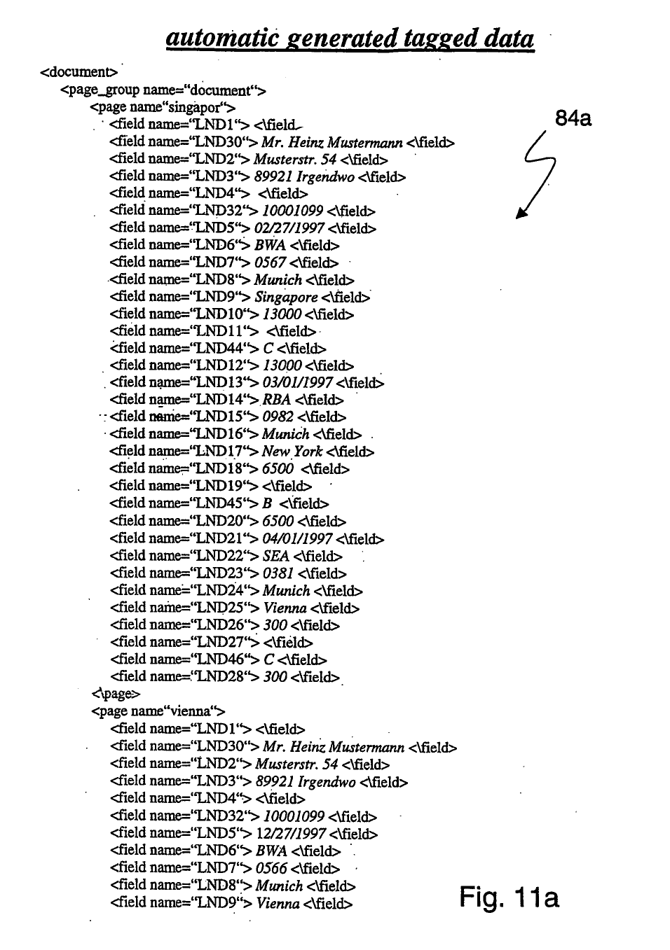

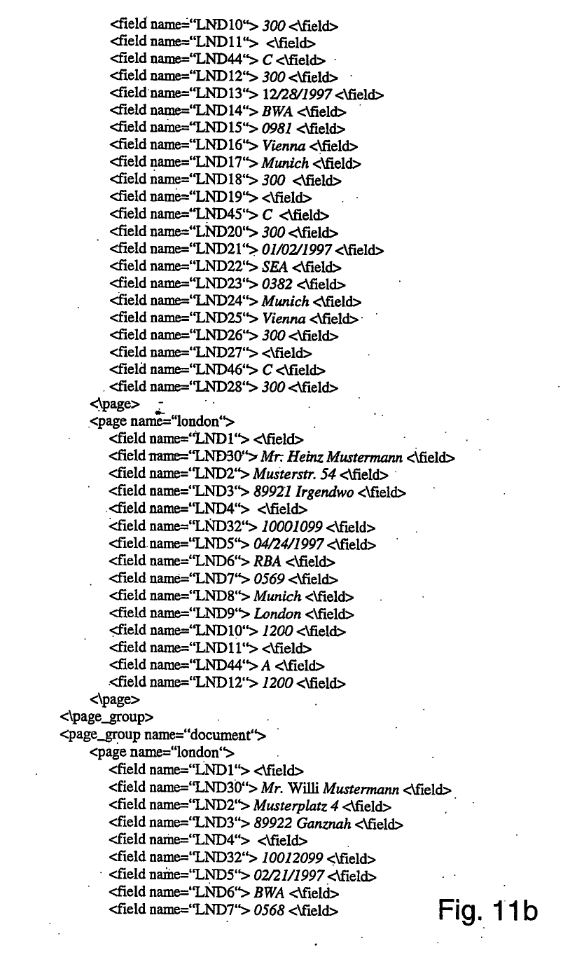

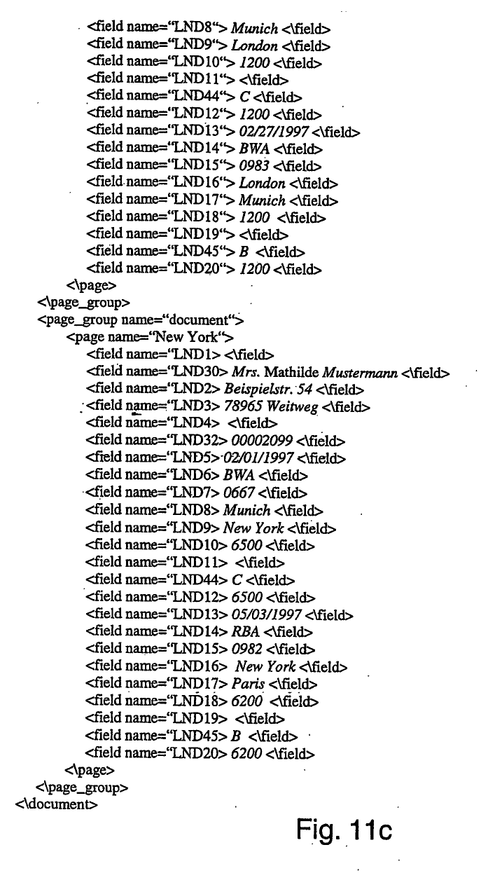

FIGS. 11a, 11b and 11c show how a page structure is generated by means of a corresponding page description file, in which page structure a new page is begun for each person and the flights of one person are shown on one or more pages.

Customer-specific code pages used in the labeled data structure 83a can be recoded (for example converted to Unicode) in the course of the formation of the data stream structured per page and/or per region. Furthermore, graphic objects, images and so forth can be converted into corresponding typed, normalized usable data fields of the data stream structured per page and/or per region.

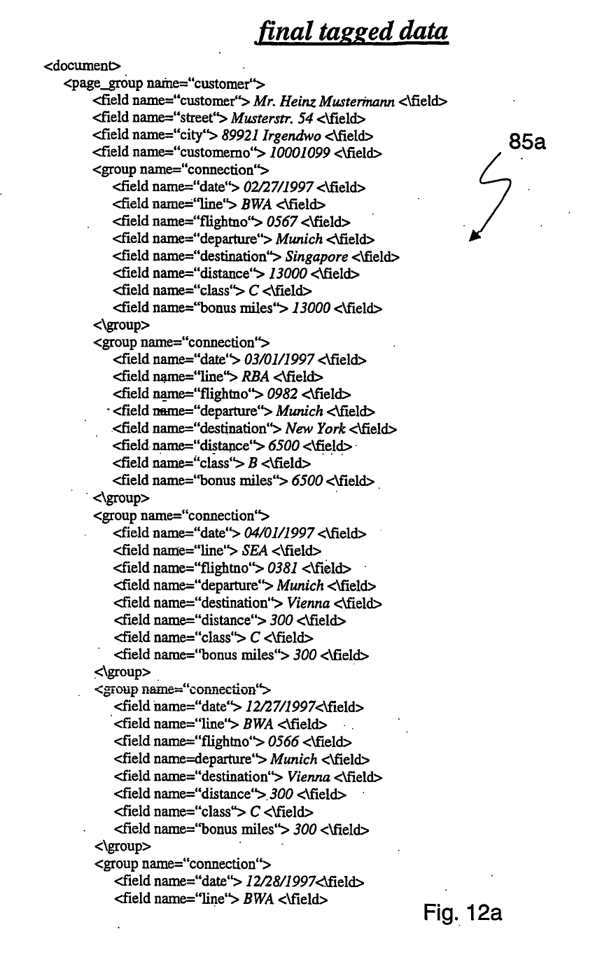

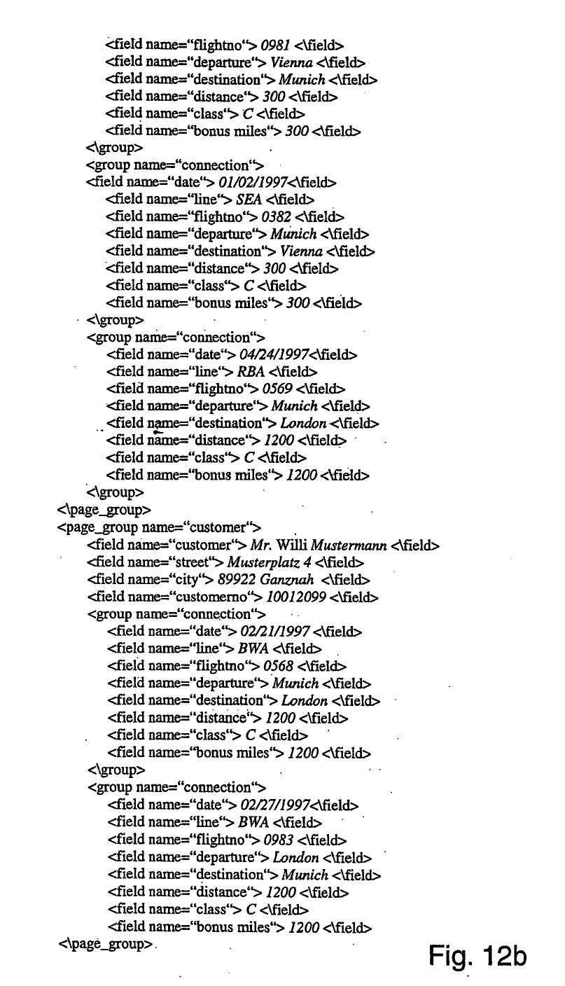

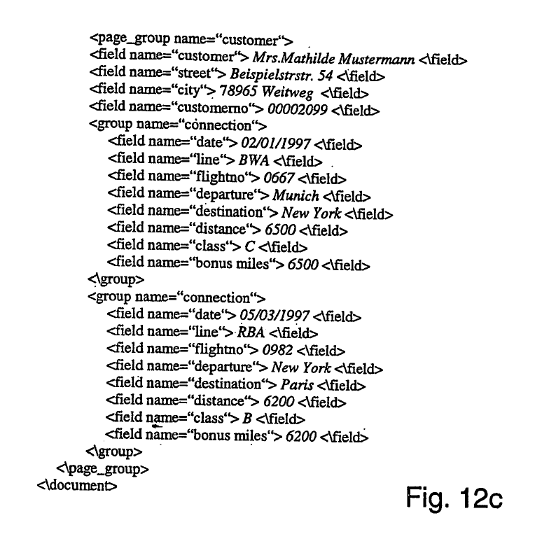

The final labeled data stream 85a that is formed from the labeled data structure 83a and is structured in groups in regions is shown in FIGS. 12a, 12b and 12c. The field “customer” thereby respectively comprises forms of address, first names and last names of the flight passenger and is respectively handled as a field with these three specifications. Such a combined field can, however, be separated at any time into its individual components and thus a plurality of fields that respectively correspond to a corresponding entry in a databank can be generated from such a field. The data stream 85a serves for the further processing as an input data stream of a formatter.

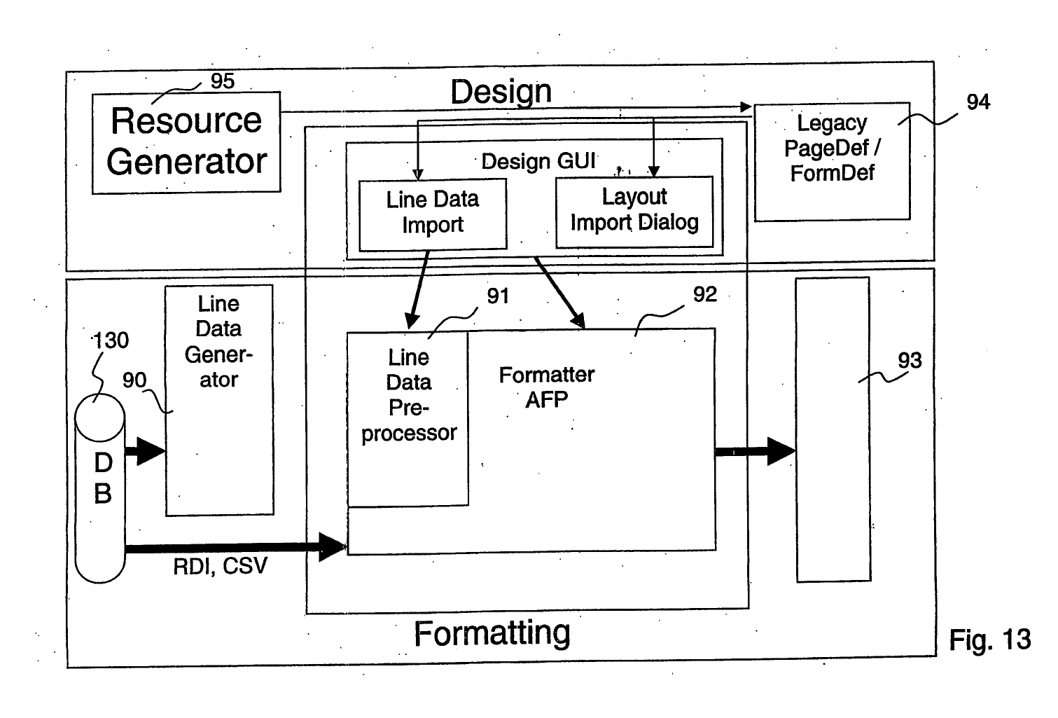

Shown in FIG. 13 is an exemplary embodiment in which a line data print data stream is generated from a databank 130 by means of a line data generator, is supplied (with the previously described measures) to a line data pre-processor 91 in which the line data print data stream is converted into a data stream structured per page and/or per region, and this data stream is supplied to a formatter 92 in which additional formatting elements are added to the data stream. The data stream completely formatted in such a manner is then supplied to an output device 93, whereby various resources 94 (such as overlays and fonts) can be added to the data stream. These resources can be generated with known resource generators 95 and are additionally used in order to control the line data pre-processor 91 (line data import dialog) and to control the layout generated in the formatter 92 (layout import dialog).

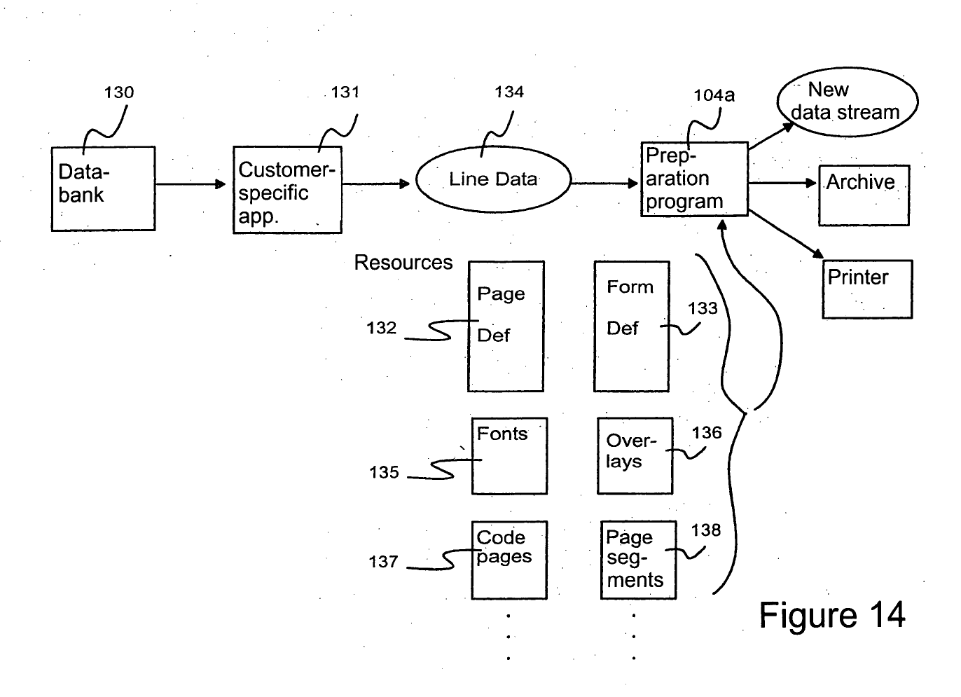

What is known as a legacy application is shown in FIG. 14, in which AFP line data print data 134 are generated in a customer-specific application 131, whereby raw data are extracted from a databank 130 and output oriented per line and/or per page. Corollary files such as a pagedef file 132 and a formdef file 133 and, if applicable, further resources such as fonts 135, overlays 136, code pages 137, page segments 138 and so forth are additionally provided. When an output print data stream should be generated from the line data print data stream 134, for example for output on a print device or in an archive, the line data are then merged or combined again with the corollary files or resources by means of a preparation program 104a (such as, for example, the aforementioned program Océ PRISMAproduction™).

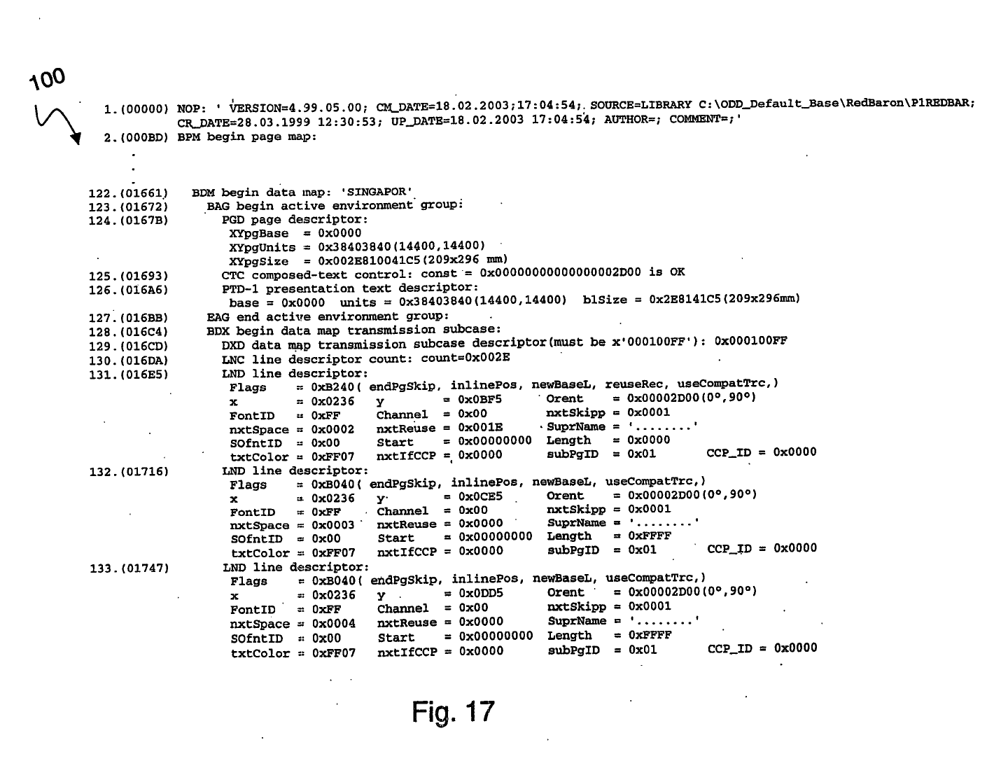

An excerpt from a pagedef file “P1 redbar” prepared so as to be readable by people is shown in FIG. 17a, with which pagedef file “P1 redbar” a legacy print data application is generated from the line data shown in FIGS. 7 through 12. The successive numbers of the structured fields in the pagedef file are specified in the first column 100 of the excerpt.

The parameters that are contained in the individual structured fields are listed in hexadecimal (in machine code) after the equals sign. In the section line descriptor structured fields (LNDs) are to be seen that can be used as sources for generation of the automatic design data set.

A line data stream is processed line for line with the machine commands.

The invention was specified using exemplary embodiments. It is thereby clear that the average man skilled in the art can specify modifications at any time. The cited print data languages are in particular to be understood as only exemplary since these are steadily further developed, as is clear at the point in time of the present application in the two print data languages Extensible Mark-up Language (XML) and Personalized Printer Mark-up Language (PPML).

The preferred embodiment was in particular specified using AFP example data streams and files. However, it is clear that the preferred embodiment is also applicable for other line data streams with corresponding data or files there and is not limited to AFP data streams.

Furthermore, the described printing method is not limited to specific printing materials such as paper or to specific recording medium forms such as endless webs or individual sheets.

The preferred embodiment is in particular suited to be realized as a computer program (software). As a computer program module it can therewith be distributed as a file on a data medium such as a diskette, DVD-ROM or CD-ROM or as a file via a data or communication network. Such and comparable computer program products or computer program elements are other embodiments of the invention. It is thereby clear that corresponding computers on which the preferred embodiment is applied can comprise further known technical devices such as input means (keyboard, mouse, touchscreen), a microprocessor, a data or control bus, a display device (monitor, display) as well as a working memory, a fixed disc storage and a network card.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

1-28. (canceled)

29. A method for generation of a mapping rule with which input data of a print data stream structured per line and which comprises variable data to be printed can be converted into output data of an output data structure, comprising the steps of:
with a predetermined structure description file associated with the print data stream and establishing an arrangement of the data to be printed on a page upon printout, automatically generating an automatic design data set in which structurally associated print data are comprised structured at least one of per page or per region;
generating the mapping rule by use of a design data set that corresponds to the output data structure and by use of the automatic design data set, the mapping rule describing mapping of data of the automatic design data set to the design data set; and
structuring the output data structure with respect to content, said output data structure comprising field identifiers that are associated with the data to be printed.

30. A method according to claim 29 wherein the design data set corresponds to the output data structure and the mapping rule is generated such that it describes a mapping between entries of the structure description file and entries of the design data set.

31. A method according to claim 29 wherein Advanced Function Presentation line data print data are used as line data print data, the page definition file is an AFP pagedef file and an automatic structural composition at least one of per page or per region occurs in that LND line descriptors that originate from the AFP pagedef file are associated with respective fields from the line data structure.

32. A method according to claim 29 wherein the output data stream is coded in Unicode.

33. A method according to claim 32 wherein code pages from font assignments from the structure description file are checked for consistency with the Unicode coding, and conflicts are resolved via code-specific mappings to Unicode.

34. A method according to claim 29 wherein the mapping rule is automatically generated and heuristics are applied that analyze and/or interpret print instructions of the structure description file and/or identifying data associated with them according to their actual calls upon processing of line data of the print data stream structured per line.

35. A method according to claim 29 wherein formatting elements are associated with the line data input print data stream before the output data stream structured at least one of per page or per region is generated.

36. A method according to claim 35 wherein the association of the formatting elements occurs with an editor.

37. A method according to claim 35 wherein the formatting elements are graphical elements.

38. A method according to claim 37 wherein the graphical elements are pie charts or bar diagrams.

39. A method for generation of a mapping rule with which input data of a print data stream structured per line and which comprises variable data to be printed can be converted into output data of an output data structure, comprising the steps of:
with a predetermined structure description file associated with the print data stream and establishing an arrangement of the data to be printed on a page upon printout, automatically generating an automatic design data set in which structurally associated print data are comprised structured per location;
generating the mapping rule by use of a design data set that corresponds to the output data structure by use of the automatic data set, the mapping rule describing the mapping of data of the automatic design data set to the design data set; and
structuring the output data structure with respect to content, said output data structure comprising field identifiers that are associated with the data to be printed.

40. A method of claim 39 wherein said structuring per location comprises structuring per page.

41. A method of claim 39 wherein said structuring per location comprises structuring per region.

42. A method for generation of an output data stream structured at least one of per page or per region from a line data input print data stream structured per line with which is associated in a fixed manner a structure description file, comprising the steps of:
generating a mapping rule between the structure description file and a design data set that corresponds to an output data structure by use of an automatic design data set, the automatic design data set being automatically generated and in which structurally associated print data are comprised structured at least one of per page or per region; and
by use of the mapping rule generating the output data stream structured at least one of per page or per region from the line data input print data stream structured per line.

43. A method according to claim 42 wherein field identifiers of the output data structures comprise structure criteria with regard to content with field names.

44. A method according to claim 43 wherein given automatic generation of the automatic design data set with the structurally associated print data, identifying data associated with them are combined structured at least one of per page or per region.

45. A method according to claim 44 wherein for generation of the automatic design data set or to form the mapping rule, in addition to the page definition file at least one of a page association file associated with it or associated resources are used.

46. A method according to claim 43 wherein data sets of the line data print data stream corresponding to field positions from the structure description file are allocated for generation of the automatic design data set.

47. A method according to claim 43 wherein an intermediate file is generated before the generation of the automatic design data set, and in the intermediate file the line data print data associated in terms of content and/or structure are combined within a structure bracket.

48. A method according to claim 42 wherein the structure description file, at least parts of the line data stream, and/or data input and/or selected by an operator are used for generation of the mapping rule and a rule file is formed that comprises the mapping rule and that is used for generation of the print data stream structured at least one of per page or per region.

49. A method according to claim 42 wherein the data stream structured at least one of per page per region comprises data pairs made up of field identifiers and associated field values.

50. A method according to claim 42 wherein the data stream structured at least one of per page per region comprises groups of data fields belonging together.

51. A method according to claim 42 wherein the print data stream structured at least one of per page per region is generated as comma-separated values print data stream or as an Extensible Markup Language data stream.

52. A method according to claim 42 wherein the data stream structured at least one of per page or per region or a data stream derived therefrom is used as an input data stream for a formatter and a formatted print data stream is formed in the formatter.

53. A method according to claim 52 wherein an MO:DCA data stream is formed as the formatted print data stream.

54. A method according to claim 52 wherein structure and/or formatting elements input or selected by an operating personnel are added to the formatter input data stream via the formatter.

55. A method according to claim 52 wherein a document template is supplied to the formatter and the data stream structured at least one of per page or per region is converted into an internal data format; document formatting information is added to the data in the internal data format; said document formatting information establishing a content of the data stream in the internal data format is represented in the formatted print data stream; and the data are output as a formatted print data stream.

56. A printing system for generation of a mapping rule with which input data of a print data stream structured per line and which comprises variable data to be printed can be converted into output data of an output data structure, comprising:
means for automatically generating an automatic design data set in which structurally associated print data are comprised structured at least one of per page or per region by a predetermined structure description file associated with the print data stream when establishing an arrangement of a data to be printed on a page upon printout;
means for generating the mapping rule by use of a design data set that corresponds to the output data structure and by use of the automatic design data set, the mapping rule describing the mapping of data of the automatic design data set to the design data set; and
means for structuring the output data structure with respect to content, said output data structure comprising field identifiers that are associated with the data to be printed.

57. A device according to claim 56 comprising:
a computer on which a software program runs with which for generation of a mapping rule with which input data of a print data stream structured per line can be converted into output data of an output data structure;
an automatic design data set in which are comprised structurally associated print data structured at least one of per page or per region is automatically generated by means of a predetermined structure description file associated with the print data stream structured per line and establishing the arrangement of the data to be printed on the page upon printout;
the mapping rule being generated by a design data set that corresponds to the output data structure and by the automatic design data set;
the output data structure being structured with respect to content and comprises field identifiers that are associated with the data to be printed; and
the mapping rule describing the mapping of data of the automatic design data set to the design data set.

58. A computer program product for generation of a mapping rule with which input data of a print data stream structured per line and which comprises variable data to be printed can be converted into output data with an output data structure, said computer program product performing the steps of:
with a predetermined structured description file associated with the print data stream and establishing an arrangement for the data to be printed on a page upon printout, automatically generating an automatic design data set in which structurally associated print data are comprised structured at least one of per page or per region;
generating the mapping rule by use of a design data set that corresponds to the output data structure and by use of the automatic data set, the mapping rule describing mapping of data of the automatic design data set to the design data set; and
structuring the output data structure with respect to content, said output data structure comprising field identifiers that are associated with the data to be printed.
